(19) United States
(12) Patent Application Publication
(10) Pub. No.: US 2019/0016880 A1
(43) Pub. Date: Jan. 17, 2019

(54) An Amphoteric Polymer and an Alkenyl Succinic Anhydride Emulsion Containing the Same

(71) Applicant: Ecolab USA Inc., St. Paul, MN (US)

(72) Inventors: Kun Hou, Shanghai (CN); Yongquan Dong, Shanghai (CN); Bo Zhu, Shanghai (CN); Zhi Chen, Shanghai (CN)

(73) Assignee: Ecolab USA Inc., St. Paul, MN (US)

(21) Appl. No.: 16/066,960

(22) PCT Filed: Dec. 19, 2016
(86) PCT No.: PCT/US2016/067473

§ 371 Date: Jun. 28, 2018

(30) Foreign Application Priority Data
Dec. 31, 2015 (CN) 201511026730.X

(51) Int. Cl. C08L 33/26; C08F 220/56; D21H 17/45; D21H 21/16; D21H 23/04

(52) U.S. Cl. CPC C08L 33/26; C08F 220/56; D21H 17/455; C08L 2201/52; D21H 23/04; C08F 2800/10; D21H 21/16

(57) ABSTRACT

The present invention is directed to an amphoteric polymer, a method for preparing an amphoteric polymer, use of the amphoteric polymer for emulsifying an alkenyl succinic anhydride. The present invention also provides an alkenyl succinic anhydride emulsion prepared using the amphoteric polymer, and a method for sizing paper using an alkenyl succinic anhydride emulsion prepared using the amphoteric polymer. The amphoteric polymer of the present invention is obtained by copolymerization of cationic monomers, non-ionic monomers, and anionic monomers.

### CROSS-REFERENCE TO RELATED APPLICATION

This patent application claims the benefit of Chinese Patent Application No. 201511026730.X, filed Dec. 31, 2015, which is incorporated by reference in its entirety.

### TECHNICAL FIELD

The present application relates to the field of papermaking, and particularly relates to an alkenyl succinic anhydride emulsion for sizing paper in a papermaking process.

### BACKGROUND OF THE INVENTION

Alkenyl succinic anhydride (ASA) emulsions are commonly used as sizing agents in papermaking processes. ASA emulsions are generally emulsified on site, and immediately added to the papermaking process. The most widely used ASA emulsifiers are cooked cationic starches. However, the use of large quantities of starch generally increases the chemical oxygen demand (COD) of papermaking processes. Due to environmental concerns, there have been stricter regulations regarding wastewater discharge from paper mills. As a result, papermaking companies are now researching and developing new high molecular polymer emulsifiers to replace the use of starch emulsifiers.

Currently, there are a small number of polymer emulsifiers that are commercially available. ASA emulsions prepared using commercially available emulsifiers have exhibited problems when used in papermaking processes. For example, such ASA emulsions are often sensitive to hardness and alkalinity in paper mill water. Furthermore, it has been observed that sizing processes that include ASA emulsions are often very sensitive to paper ash ratio. ASA emulsions are also known to form a yellow adhesive upon hydrolysis, severely limiting the grade and class of paper that the ASA emulsion can be used to size.

Accordingly, there is a need for developing an ASA emulsion suitable for sizing a variety of grades of paper.

### BRIEF SUMMARY OF THE INVENTION

In an embodiment, the present invention provides a method for preparing an amphoteric polymer.

In another embodiment, the present invention provides an amphoteric polymer.

In another embodiment, the present invention provides the use of an amphoteric polymer for emulsifying an alkenyl succinic anhydride.

In another embodiment, the present invention provides an alkenyl succinic anhydride emulsion prepared using an amphoteric polymer.

In another embodiment, the present invention provides a method for sizing paper using an alkenyl succinic anhydride emulsion prepared using an amphoteric polymer.

### BRIEF DESCRIPTION OF THE DRAWINGS

FIG. 1 shows the D50 particle size vs. the aging time of an ASA emulsion in deionized water and tap water, according to an embodiment of the present invention.

FIG. 2 shows the particle size distribution of an ASA emulsion after aging for 22 days, according to an embodiment of the present invention.

### DETAILED DESCRIPTION OF THE INVENTION

The embodiments of the present application are expounded as follows. It should be understood that, the embodiments described herein are merely for illustrating and explaining the present application, rather than to limit the present application.

In an embodiment, the present invention provides a method for preparing an amphoteric polymer. The method comprises copolymerizing a cationic monomer, a non-ionic monomer, and an anionic monomer in the presence of an initiator and a crosslinker to obtain the amphoteric polymer.

In certain embodiments, the cationic monomer comprises diallyl-N,N-dimethyl ammonium chloride, methacryloyloxyethyl-trimethylammonium chloride, methacryloyloxyethyltrimethylammonium sulfate, methacryloyloxyethyldimethylphenylammonium chloride, acryloyloxyethyl-trimethylammonium chloride, acryloyloxyethyltrimethylammonium sulfate, acryloyloxyethyldimethylphenylammonium chloride, N,N,N-trimethyl-3-(2-methylacrylamino)-1-propyl ammonium chloride, methacrylic N,N′-dimethylamino ethyl ester, methacrylic N,N′-dimethylamino ethyl ester quaternary ammonium salt cation, acrylic-(dimethylamino) ethyl ester, acrylic-(dimethylamino) ethyl ester quaternary ammonium salt, acrylic-(diethylamino) ethyl ester, acrylic-(diethylamino) ethyl ester quaternary ammonium salt, or a combination thereof. In certain embodiments, the cationic monomer is diallyl-N,N-dimethyl ammonium chloride or methacryloyloxyethyltrimethylammonium chloride.

In certain embodiments, the non-ionic monomer comprises or is acrylamide, methacrylamide, N,N-dimethylacrylamide, N,N-diethylacrylamide, N-isopropylacrylamide, N-vinylformamide, N-vinyl-N-methylacetamide, N-vinyl-2-pyrrolidone, or a combination thereof. In certain embodiments, the non-ionic monomer is acrylamide or methacrylamide.

In certain embodiments, the anionic monomer is selected from acrylic acid, methacrylic acid, a salt thereof, or a combination thereof. In certain embodiments, the anionic monomer is acrylic acid, sodium acrylate, ammonium acrylate, or a combination thereof. In certain embodiments, the anionic monomer is methacrylic acid, sodium methacrylate, ammonium methacrylate, or a combination thereof. In certain embodiments, the anionic monomer is acrylic acid or methacrylic acid.

In certain embodiments, the crosslinker comprises, but is not limited to, triallylamine, dimethylacrylamide, N,N-methylene diacrylamide, or a combination thereof.

In certain embodiments, the initiator comprises, but is not limited to, ammonium persulphate, potassium persulphate, sodium persulphate, or a combination thereof. The amount of the initiator may be determined by a person skilled in the art according to actual conditions.

In certain embodiments, the mole ratio of the non-ionic monomer:the cationic monomer:the anionic monomer:the crosslinker is about 64-94:30-5:10-1:0.05-0.20 (i.e., about 64-94 to about 30-5 to about 10-1 to about 0.05-0.20). In certain embodiments, the mole ratio of the non-ionic monomer:the cationic monomer:the anionic monomer:the crosslinker is about 70-89:20-10:10-1:0.1-0.20 (i.e., about 70-89 to about 20-10 to about 10-1 to about 0.1-0.20). In certain embodiments, the mole ratio of the non-ionic monomer:the cationic monomer:the anionic monomer:the crosslinker is about 80-89:15-10:5-1:0.1-0.15 (about 80-89 to about 15-10 to about 5-1 to about 0.1-0.15).

In certain embodiments, the copolymerizing comprises: mixing the non-ionic monomer, the anionic monomer, the crosslinker, and the cationic monomer, and adding the initiator to conduct copolymerization; or mixing the cationic monomer and the initiator, and adding the non-ionic monomer, the anionic monomer, and the crosslinker to conduct copolymerization.

In certain embodiments, the copolymerizing comprises: preparing a monomer solution A by mixing the non-ionic monomer, the anionic monomer, the crosslinker and water; preparing an initiator aqueous solution by mixing the initiator and water; adding (e.g., dropwise) the initiator aqueous solution into a reactor containing water with a temperature of 70-90° C., and adding (e.g., dropwise) simultaneously the monomer solution A and the cationic monomer. In certain embodiments, the method comprises adding simultaneously the monomer solution A and the cationic monomer after adding the initiator aqueous solution for three minutes; continually adding the initiator aqueous solution after finishing addition of the monomer solution A and the cationic monomer, optionally continually adding the initiator aqueous solution for 15 to 30 minutes, and then maintaining the temperature at 70-90° C. until the reaction is completed to obtain an amphoteric polymer. In certain embodiments, the temperature is maintained for 2 hours.

In certain embodiments, the copolymerizing comprises: preparing a monomer solution A by mixing the non-ionic monomer, the anionic monomer, the crosslinker and water; preparing an initiator aqueous solution by mixing the initiator and water; adding the cationic monomer and water into a reactor, heating the reactor to a temperature of 70-90° C., adding (e.g., dropwise) the initiator aqueous solution, and adding (e.g., dropwise) the monomer solution A. In certain embodiments, the method comprises adding the monomer solution A after adding the initiator aqueous solution for three minutes, adding the initiator aqueous solution after finishing the addition of the monomer solution A, optionally continually adding the initiator aqueous solution for 15 to 30 minutes, and then maintaining the temperature at 70-90° C. until the reaction is completed to obtain an amphoteric polymer, and optionally maintaining the temperature for 2 hours.

In certain embodiments, the term “water” refers to tap water and/or deionized water.

In another embodiment, the present invention provides an amphoteric polymer prepared by the aforementioned method.

In certain embodiments, the ratio of anionic charge to cationic charge in the amphoteric polymer is about 1:20 to about 5:10. In certain embodiment, the ratio of anionic charge to cationic charge in the amphoteric polymer is about 1:20 to about 5:15. In certain embodiments, the molecular weight of the amphoteric polymer is about 100,000 to about 2,000,000 Daltons. In certain embodiments, the molecular weight of the amphoteric polymer is about 250,000 to about 1,500,000 Daltons. In certain embodiments, the molecular weight of the amphoteric polymer is about 400,000 to about 1,200,000 Daltons.

In certain embodiments, the viscosity of the amphoteric polymer is about 10 to about 10,000 cps. In certain embodiments, the viscosity of the amphoteric polymer is about 1,000 to about 5,000 cps. In certain embodiments, the viscosity of the amphoteric polymer is about 1,000 to about 4,000 cps.

In another embodiment, the present invention provides the use of the above amphoteric polymer for emulsifying an alkenyl succinic anhydride (ASA).

In the present application, the term “alkenyl succinic anhydride” or “ASA” has the following structure:

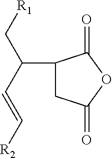

wherein, R₁ and R₂ is alkyl, and the total number of carbon atoms of R₁ and R₂ is from 8 to 18.

In another embodiment, the present invention provides an alkenyl succinic anhydride emulsion comprising the aforementioned amphoteric polymer, an alkenyl succinic anhydride, and water.

In certain embodiments, the alkenyl succinic anhydride emulsion comprises about 0.01 to about 20 parts by weight of the amphoteric polymer, about 0.01 to about 20 parts by weight of the alkenyl succinic anhydride, and about 60 to about 99.98 parts by weight of water. In certain embodiments, the alkenyl succinic anhydride emulsion comprises about 0.5 to about 8 parts by weight of the amphoteric polymer, about 1 to about 8 parts by weight of the alkenyl succinic anhydride, and about 82 to about 98 parts by weight of water. In certain embodiments, the alkenyl succinic anhydride emulsion comprises about 0.7 to about 2 parts by weight of the amphoteric polymer, about 2 to about 5 parts by weight of the alkenyl succinic anhydride, and about 93 to about 97.3 parts by weight of water.

In certain embodiments, the order of addition of the amphoteric polymer, alkenyl succinic anhydride, and water to make the ASA emulsion is not particularly limited.

In another embodiment, the present invention provides a method for sizing paper comprising adding the alkenyl succinic anhydride emulsion into the papermaking furnish.

In certain embodiments, the alkenyl succinic anhydride emulsion is diluted with a cationic cooked starch so that the weight ratio of the alkenyl succinic anhydride to dry cationic cooked starch is about 1:1 to about 1:2, and the diluted alkenyl succinic anhydride emulsion is added to the papermaking furnish for sizing.

In certain embodiments, the alkenyl succinic anhydride emulsion is added in an amount of about 0.1 to about 5 kg of the alkenyl succinic anhydride per ton of dried papermaking furnish.

In certain embodiments, the ASA emulsion prepared with the amphoteric polymer of the embodiment of the present invention has high stability. In certain embodiments, the ASA emulsion of the present invention is used for sizing cultural paper having an ash content of about 20 wt % or more. In certain embodiments, the ASA emulsion of the present invention is used for sizing paperboard.

In certain embodiments, use of the amphoteric polymer emulsifier of the present invention decreases the chemical oxygen demand (COD) in waste water discharged from a paper mill and is more environment-friendly. In certain embodiments, a papermaking method comprising the use of an amphoteric polymer emulsifier of the present invention requires less energy than a method comprising the use of a cationic cooked starch.

In certain embodiments, an ASA emulsion prepared with the amphoteric polymer emulsifier of an embodiment of the present invention can be stable for over two weeks in tap water (e.g., having a hardness of about 200 ppm or less) without the formation of a yellow adhesive.

### Example 1

### Preparation of Amphoteric Polymer

267.9 g of acrylamide (concentration 50.0%, 1.8845 mol), 8.5 g of acrylic acid (concentration 100%, 0.1180 mol), 0.32 g of triallylamine (TAA, 100% concentration, 2.33 mmol), and 270 g of water were mixed and stirred evenly to prepare a monomer solution A. 1.3 g of ammonium persulphate (APS) was dissolved in 31.7 g of water to prepare an initiator aqueous solution. 325 g of water was added in a flask and then heated to 80-90° C.; after the water was fed with nitrogen gas for half an hour, the initiator aqueous solution was added dropwise thereinto; three minutes later, 92.3 g of diallyl-N,N-dimethyl ammonium chloride (DADMAC, concentration 62.0%, 0.3542 mol) and the monomer solution A were added dropwise thereinto at the same time. Three hours later, the dropwise addition of DADMAC and the monomer solution A was completed, and the initiator aqueous solution was continually added dropwise for 15-30 minutes, kept at the temperature of 80-90° C. for 2 hours, and an amphoteric polymer aqueous solution (effective component 20 wt %) was obtained. The pH value of the amphoteric polymer aqueous solution was about 4, the viscosity was 6800 cps (Brookfield viscometer, 4# spindle, rotating speed is 30 rpm), and the molecular weight was 930,000 Daltons.

### Example 2

### Preparation of Amphoteric Polymer

184.6 g of acrylamide aqueous solution (concentration 50.0%, 1.299 mol), 8.8 g of acrylic acid (concentration 100%, 0.1221 mol), 0.32 g of triallylamine (TAA, 100% concentration, 2.33 mmol), and 284.3 g of water were mixed and stirred evenly to prepare a monomer solution A. 1.3 g of ammonium persulphate (APS) was dissolved in 31.7 g of water to prepare an initiator aqueous solution. 330.6 g of water was added in a flask and then heated to 80-100° C.; after the water was fed with nitrogen gas for half an hour, the initiator aqueous solution was added dropwise thereinto; three minutes later, 159.0 g of diallyl-N,N-dimethyl ammonium chloride (DADMAC, concentration 62.0%, 0.6101 mol) and the monomer solution A were added dropwise thereinto at the same time. Three hours later, the dropwise addition of DADMAC and the monomer solution A was completed, and the initiator solution was continually added dropwise for 15-30 minutes, kept at the temperature of 80-90° C. for 2 hours, and an amphoteric polymer aqueous solution (effective component 20 wt %) was obtained. The pH value of the amphoteric polymer aqueous solution was about 4, the viscosity was 4200 cps (Brookfield viscometer, 4# spindle, rotating speed is 6 rpm), and the molecular weight was 920,000 Daltons.

### Example 3

### Preparation of Amphoteric Polymer

296.2 g of acrylamide aqueous solution (concentration 50.0%, 1.9720 mol), 9.0 g of acrylic acid (concentration 100%, 0.1249 mol), 0.34 g of triallylamine (TAA, 100% concentration, 2.33 mmol), and 262 g of water were mixed and stirred evenly to prepare a monomer solution A. 1.3 g of ammonium persulphate (APS) was dissolved in 31.7 g of water to prepare an initiator aqueous solution. 330 g of water was added in a flask and then heated to 80-100° C.; after the water was fed with nitrogen gas for half an hour, the initiator aqueous solution was added dropwise thereinto; three minutes later, 65 g of diallyl-N,N-dimethyl ammonium chloride (DADMAC, concentration 62.0%, 0.2494 mol) and the monomer solution A were added dropwise thereinto at the same time. Three hours later, the dropwise addition of DADMAC and the monomer solution A was completed, and the initiator solution was continually added dropwise for 15-30 minutes, kept at the temperature of 80-90° C. for 2 hours, and an amphoteric polymer aqueous solution (effective component 20 wt %) was obtained. The pH value of the amphoteric polymer aqueous solution was about 4, the viscosity was 8042 cps (Brookfield viscometer, 4# spindle, rotating speed is 30 rpm), and the molecular weight was 1,200,000 Daltons.

### Example 4

### Preparation of Amphoteric Polymer

266.3 g of acrylamide aqueous solution (concentration 50.0%, 1.873 mol), 1.6 g of acrylic acid (concentration 100%, 0.222 mol), 0.34 g of triallylamine (TAA, 100% concentration, 2.33 mmol), and 267 g of water were mixed and stirred evenly to prepare a monomer solution A. 1.3 g of ammonium persulphate was dissolved in 31.7 g of water to prepare an initiator aqueous solution. 330 g of water was added in a flask and then heated to 80-100° C.; after the water was fed with nitrogen gas for half an hour, the initiator aqueous solution was added dropwise thereinto; three minutes later, 116.9 g of diallyl-N,N-dimethyl ammonium chloride (DADMAC, concentration 62.0%, 0.4487 mol) and the monomer solution A were added dropwise thereinto at the same time. Three hours later, the dropwise addition of DADMAC and the monomer solution A was completed, and the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 5135 cps (Brookfield viscometer, 4# spindle, rotating speed is 30 rpm), and the molecular weight was 1,000,000 Daltons.

### Example 5

### Preparation of Amphoteric Polymer

266.3 g of acrylamide (concentration 50.0%, 1.874 mol), 8.5 g of acrylic acid (concentration 100%, 0.1180 mol), 1.168 g of N,N-dimethylacrylamide (DMAA, 100%, 0.0118 mol), and 261 g of water were mixed and stirred evenly to prepare a monomer solution A. 1.615 g of ammonium persulphate was dissolved in 30.68 g of water to prepare an initiator aqueous solution. 335.2 g of water and 92.2 g of diallyl-N,N-dimethyl ammonium chloride (DADMAC, concentration 62.0%, 0.3542 mol) were put into a flask and stirred evenly; after being fed with nitrogen gas for half an hour, the solution was heated to 70-90° C., and then the initiator aqueous solution was added dropwise thereinto; three minutes later, the monomer solution A was added dropwise thereinto. Three hours later, the dropwise addition of the monomer solution A was completed, the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 2623 cps (Brookfield viscometer, 2# spindle, rotating speed is 30 rpm), and the molecular weight was 590,000 Daltons.

### Example 6

### Preparation of Amphoteric Polymer

183.3 g of acrylamide aqueous solution (concentration 50.0%, 1.29 mol), 8.8 g of acrylic acid (concentration 100%, 0.122 mol), 1.00 g of N,N-dimethylacrylamide (DMAA, 100%, 0.01 mol), and 261 g of water were mixed and stirred evenly to prepare a monomer solution A. 1.62 g of ammonium persulphate (APS) was dissolved in 30.68 g of water to prepare an initiator aqueous solution. 351.4 g of water and 158.92 g of diallyl-N,N-dimethyl ammonium chloride (DADMAC, concentration 62.0%, 0.2494 mol) were put into a flask and the water was heated to 70-90° C.; then after the water was fed with nitrogen gas for half an hour, the initiator aqueous solution was added dropwise thereinto. Three minutes later, the monomer solution A was added dropwise thereinto. Three hours later, the dropwise addition of the monomer solution A was completed, and the initiator solution was continually added dropwise for 15-30 minutes, kept at the temperature of 70-90° C. for 2 hours, an amphoteric polymer aqueous solution (effective component 20 wt %) was obtained. The pH value of the amphoteric polymer aqueous solution was about 4, the viscosity was 1542 cps (Brookfield viscometer, 2# spindle, rotating speed is 30 rpm), and the molecular weight was 400,000 Daltons.

### Example 7

### Preparation of Amphoteric Polymer

299.1 g of acrylamide (50.0% concentration, 2.10 mol), 8.97 g of acrylic acid (concentration 100%, 0.124 mol), 1.234 g of N,N-dimethylacrylamide (DMAA, 12.44 mmol), and 261 g of water were mixed and stirred evenly to prepare a monomer solution A. 1.62 g of ammonium persulphate was dissolved in 30.7 g of water to prepare an initiator aqueous solution. 329 g of water and 64.9 g of diallyl-N,N-dimethyl ammonium chloride (DADMAC, concentration 62.0%, 0.249 mol) were put into a flask and the water was heated to 70-90° C.; then after the water was fed with nitrogen gas for half an hour, the initiator aqueous solution was added dropwise thereinto; three minutes later, the monomer solution A was added dropwise thereinto. Three hours later, the dropwise addition of the monomer solution A was completed, the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 2935 cps (Brookfield viscometer, 2# spindle, rotating speed is 6 rpm), and the molecular weight was 620,000 Daltons.

### Example 8

### Preparation of Amphoteric Polymer

249.8 g of acrylamide (50.0% concentration, 1.76 mol), 1.61 g of acrylic acid (concentration 100%, 0.022 mol), 1.11 g of N,N-dimethylacrylamide (DMAA, 11.2 mmol), and 261 g of water were mixed and stirred evenly to prepare a monomer solution A. 1.62 g of ammonium persulphate was dissolved in 30.7 g of water to prepare an initiator aqueous solution. 334 g of water and 116.8 g of diallyl-N,N-dimethyl ammonium chloride (DADMAC, concentration 62.0%, 0.448 mol) were put into a flask and the water was heated to 70-90° C.; then after the water was fed with nitrogen gas for half an hour, the initiator aqueous solution was added dropwise thereinto; three minutes later, the monomer solution A was added dropwise thereinto. Three hours later, the dropwise addition of the monomer solution A was completed, and the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 2800 cps (Brookfield viscometer, 2# spindle, rotating speed is 6 rpm), and the molecular weight was 590,000 Daltons.

### Example 9

### Preparation of Amphoteric Polymer

268.3 g of acrylamide (50.0% concentration, 1.874 mol), 8.5 g of acrylic acid (concentration 100%, 0.1180 mol), 0.14 g of N,N-methylene diacrylamide (0.94 mmol), and 270 g of water were mixed and stirred evenly to obtain a monomer solution A. 1.292 g of ammonium persulphate was dissolved in 31.65 g of water to obtain an initiator aqueous solution. 328 g of water and 92.2 g of diallyl-N,N-dimethyl ammonium chloride (DADMAC, concentration 62.0%, 0.354 mol) were put into a flask and stirred evenly; after being fed with nitrogen gas for half an hour, the solution was heated to 70-90° C., and the initiator aqueous solution was added dropwise thereinto; three minutes later, the monomer solution A was added dropwise thereinto. Three hours later, the dropwise addition of the monomer solution A was completed, and the initiator solution was continually added dropwise for 30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 2855 cps (Brookfield viscometer, 2# spindle, rotating speed is 30 rpm), and the molecular weight was 600,000 Daltons.

### Example 10

### Preparation of Amphoteric Polymer

186.5 g of acrylamide (concentration 50.0%, 1.312 mol), 8.73 g of acrylic acid (concentration 100%, 0.121 mol), 0.125 g of N,N-methylene diacrylamide (0.81 mmol), and 270 g of water were mixed and stirred evenly to obtain a monomer solution A. 1.292 g of ammonium persulphate was dissolved in 31.65 g of water to obtain an initiator aqueous solution. 344 g of water and 157.9 g of diallyl-N,N-dimethyl ammonium chloride (DADMAC, concentration 62.0%, 0.606 mol) were put into a flask and stirred evenly; after being fed with nitrogen for half an hour, the solution was heated to 70-90° C., and the initiator aqueous solution was added dropwise thereinto; three minutes later, the monomer solution A was added dropwise thereinto. Three hours later, the dropwise addition of the monomer solution A was completed, the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 552.9 cps (Brookfield viscometer, 3# spindle, rotating speed is 30 rpm), and the molecular weight was 500,000 Daltons.

### Example 11

### Preparation of Amphoteric Polymer

301.2 g of acrylamide (concentration 50.0%, 2.118 mol), 9.0 g of acrylic acid (concentration 100%, 0.124 mol), 0.154 g of N,N-methylene diacrylamide (1.0 mmol), and 270 g of water were mixed and stirred evenly to obtain a monomer solution A. 1.292 g of ammonium persulphate was dissolved in 31.65 g of water to obtain an initiator aqueous solution. 322 g of water and 65.0 g of diallyl-N,N-dimethyl ammonium chloride (DADMAC, concentration 62.0%, 0.249 mol) were put into a flask and stirred evenly; after being fed with nitrogen gas for half an hour, the solution was heated to 70-90° C., and the initiator aqueous solution was added dropwise thereinto; three minutes later, the monomer solution A was added dropwise thereinto. Three hours later, the dropwise addition of the monomer solution A was completed, and the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 5139 cps (Brookfield viscometer, 2# spindle, rotating speed is 12 rpm), and the molecular weight is 1,200,000 Daltons.

### Example 12

### Preparation of Amphoteric Polymer

251.6 g of acrylamide (concentration 50.0%, 1.77 mol), 1.61 g of acrylic acid (concentration 100%, 0.022 mol), 0.138 g of N,N-methylene diacrylamide (0.9 mmol), and 270 g of water were mixed and stirred evenly to obtain a monomer solution A. 1.292 g of ammonium persulphate was dissolved in 31.65 g of water to obtain an initiator aqueous solution. 327 g of water and 116.8 g of diallyl-N,N-dimethyl ammonium chloride (DADMAC, concentration 62.0%, 0.448 mol) were put into a flask and stirred evenly; after being fed with nitrogen gas for half an hour, the solution was heated to 70-90° C., and the initiator aqueous solution was added dropwise thereinto; three minutes later, the monomer solution A was added dropwise thereinto. Three hours later, the dropwise addition of the monomer solution A was completed, and the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 1420 cps (Brookfield viscometer, 2# spindle, rotating speed is 30 rpm), and the molecular weight was 670,000 Daltons.

### Example 13

### Preparation of Amphoteric Polymer

247.4 g of acrylamide (concentration 50.0%, 1.74 mol), 7.86 g of acrylic acid (concentration 100%, 0.109 mol), 0.138 g of N,N-methylene diacrylamide (0.9 mmol), and 270 g of water were mixed and stirred evenly to obtain a monomer solution A. 1.292 g of ammonium persulphate was dissolved in 31.65 g of water to obtain an initiator aqueous solution. 351 g of water and 90.6 g of methacryloyloxyethyltrimethylammonium chloride (DMAEMMCQ, concentration 75%, 0.327 mol) were put into a flask and stirred evenly; after being fed with nitrogen gas for half an hour, the solution was heated to 70-90° C., and the initiator aqueous solution was added dropwise thereinto; three minutes later, the monomer solution A was added dropwise thereinto. Three hours later, the dropwise addition of the monomer solution A was completed, and the initiator solution was continually added dropwise for 15-30 minutes, kept at the temperature of 70-90° C. for 2 hours, and an amphoteric polymer aqueous solution (effective component 20 wt %) was obtained. The pH value of the amphoteric polymer aqueous solution was about 4, the viscosity was 3000 cps (Brookfield viscometer, 2# spindle, rotating speed is 30 rpm), and the molecular weight was 870,000 Daltons.

### Example 14

### Preparation of ASA Emulsion

In the measuring cup of a Philips blender, 1.4 g of amphoteric polymers prepared from Example 9 was dissolved in 97.3 g of water, and then 2 g of hexadecenylsuccinic anhydride was added thereinto. The blender was turned on, the above substance was mixed in a lower speed, then the speed of the blender was adjusted to 12000 rpm and timing was started. After the substance was stirred for 75 seconds, emulsification was ceased and an ASA emulsion was obtained.

### Example 15

### Preparation of ASA Emulsion

In the measuring cup of a Philips blender, 1.4 g of amphoteric polymers prepared from Example 5 was dissolved in 96.6 g of water, and then 2 g of hexadecenylsuccinic anhydride was added thereinto. The blender was turned on, the above substance was mixed in a lower speed, then the speed of the blender was adjusted to 12000 rpm and timing was started. After the substance was stirred for 75 seconds, emulsification was ceased and an ASA emulsion was obtained.

### Example 16

### Preparation of ASA Emulsion

In the measuring cup of a Philips blender, 10.0 g of amphoteric polymers prepared from Example 12 was dissolved in 88.0 g of water, and then 2 g of hexadecenylsuccinic anhydride was added thereinto. The blender was turned on, the above substance was mixed in a lower speed, then the speed of the blender was adjusted to 12000 rpm and timing was started. After the substance was stirred for 75 seconds, emulsification was ceased and an ASA emulsion was obtained.

### Example 17

### Preparation of Starch Post-Diluted ASA Emulsion

In the measuring cup of a Philips blender, 0.7 g of amphoteric polymers prepared from Example 9 was dissolved in 97.3 g of water, and then 2 g of hexadecenylsuccinic anhydride was added thereinto. The blender was turned on, the above substance was mixed in a lower speed, then the speed of the blender was adjusted to 12000 rpm and timing was started; after the substance was stirred for 75 seconds, emulsification was ceased. 25 g of the above emulsion was added into 50 g of cationic cooked starch solution with 1% concentration, then 25 g of water was added thereinto; after the substance was mixed evenly, a starch post-diluted ASA emulsion was obtained.

### Performances Tests

### 1. Stability

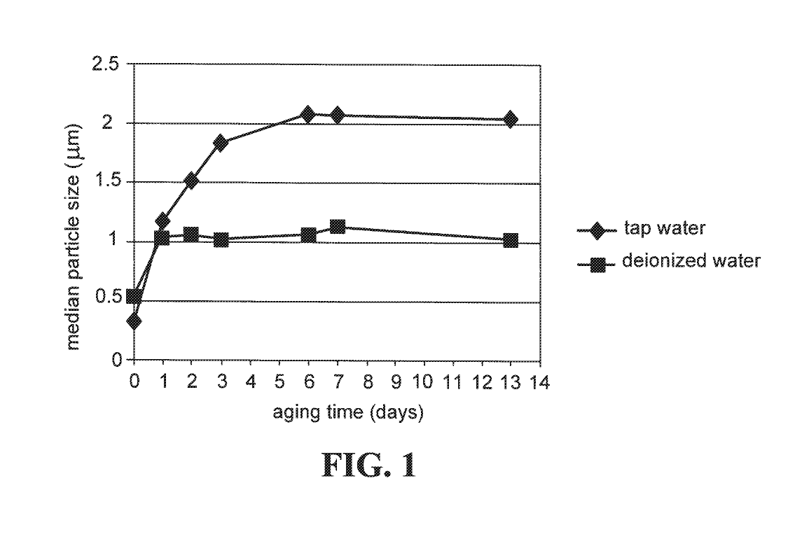

1) The D50 particle size of an ASA emulsion aged in tap water (hardness of 200 ppm) and deionized water was measured using a Malvern particle-size analyzer. The ASA emulsion was prepared with the amphoteric polymer emulsifier of Example 9 according to the process of Example 14. The result is shown in FIG. 1

As shown in FIG. 1, the ASA emulsion of substantially has a median particle size of less than 2 μm in the tap water (the hardness is 200 ppm), and has a median particle size of less than 1.5 μm in the deionized water, thus satisfying the general requirement in the field. The particles with particle size of larger than 2 μm in the emulsions are no more than 20%.

Furthermore, as shown in FIG. 1, the ASA emulsion was stable in tap water with 200 ppm hardness and deionized water for over two weeks. After two weeks, the emulsion had no stratification, no oily hydrolysate separated out, the particle size of the emulsion was maintained at about 2 μm, and there is no apparent phase separation or agglomeration. Thus, the ASA emulsion had higher stability (e.g., lower agglomeration and phase separation) such that the hydrolysis of the ASA emulsion in water is inhibited, thereby effectively improving the sizing efficiency of the ASA emulsion.

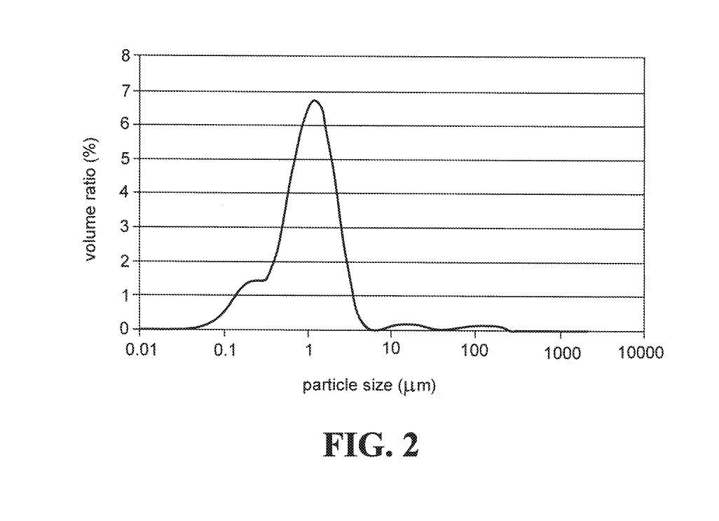

2) An ASA emulsion prepared with the amphoteric polymer emulsifier of Example 9 according to the preparation process of Example 14 was aged for 22 days. After 22 days, the particle size was measured using a Malvern particle-size analyzer. The distribution diagram is shown in FIG. 2.

As shown in FIG. 2, the ASA emulsion prepared with the emulsifier of example of the present invention remained stable. There was no observed agglomeration or stratification, and the median particle size was 0.92 μm. The ASA emulsion was extremely stable in aqueous solution and no viscous ASA hydrolysate was formed, thereby expanding the category scope of paper to which polymer emulsifier may be applied.

3) D50 particle size of the ASA emulsions prepared with the amphoteric polymer emulsifier of Examples 1-13 according to the preparation process of Example 14 and D50 particle size of the ASA emulsion prepared with the commercially available cationic starch emulsifier were tested using a Malvern particle size analyzer. The prepared respective ASA emulsions were left to stand for 4 hours and the stability was visually observed. The result is shown in Table 1.

TABLE 1
Comparison between the ASA emulsion prepared with the amphoteric
polymer emulsifiers in the embodiments of the present invention
and the ASA emulsion prepared with cationic starch emulsifier

| | ratio of | | | |
|---|---|---|---|---|
| | polymer/ASA | median | | |
| | (weight ratio | particle | | |
| | of the effective | size | <2 μm | After being left to |
| sample | components) | (μm) | (%) | stand for 4 hours |
| Example 1 | 0.14/1 | 0.413 | 100 | stable emulsion |
| Example 2 | 0.14/1 | 0.58 | 96.4 | stable emulsion |
| Example 3 | 0.14/1 | 0.484 | 99.4 | stable emulsion |
| Example 4 | 0.14/1 | 0.862 | 90.2 | stable emulsion |
| Example 5 | 0.14/1 | 0.599 | 93.7 | stable emulsion |
| Example 6 | 0.14/1 | 0.672 | 95.4 | stable emulsion |
| Example 7 | 0.14/1 | 0.605 | 96.8 | stable emulsion |
| Example 8 | 0.14/1 | 0.765 | 91.5 | stable emulsion |
| Example 9 | 0.14/1 | 0.574 | 91.6 | stable emulsion |
| Example 10 | 0.14/1 | 0.794 | 85.2 | stable emulsion |
| Example 11 | 0.14/1 | 0.484 | 89.2 | stable emulsion |
| Example 12 | 0.14/1 | 0.491 | 84.60 | stable emulsion |
| Example 13 | 0.14/1 | 0.62 | 90.0 | stable emulsion |
| cationic starch | 2/1 | 0.789 | 90.8 | agglomerated |

The result of Table 1 shows that the ASA emulsion prepared with the amphoteric polymer emulsifiers in the examples of the present invention is more stable than the ASA emulsion prepared with cationic starch emulsifier.

### 2. Sizing Effect

The water resistance properties and sizing effect of sheet samples is shown below.

1) the ASA emulsions prepared with the amphoteric polymer emulsifier of Examples 1-13 according to the preparation process of Example 14 were diluted with deionized water or tap water to form a 0.5% concentration of ASA. The ASA emulsions were added to a papermaking furnish.

Preparation of the sheet sample to be tested. Calcium carbonate filler was added to fiber furnish. The furnish was mixed for 5 seconds, and then internal starch was added thereinto. The furnish was mixed for another 15 seconds, and then a certain amount of prepared ASA emulsion was added thereinto according to the amount of absolutely dried papermaking furnish; the furnish was mixed for another 25 seconds, the retention aids of Nalco product N-61067 were added thereinto. The furnish was mixed for another 40 seconds, then the stirring was ceased. The obtained furnish was transferred to Rapid Kothen paper former for sheeting. For the furnish added with filler for sheeting, in every 100 parts by weight of furnish added with filler, the calcium carbonate filler occupied about 25 parts by weight. A sheet of paper with a diameter of 20 cm was formed by 100 mesh forming wire draining, then the sheet of paper was dried in vacuum at 96° C. for 8 minutes. The sheet was dried overnight at 24° C. to obtain the sheet to be tested.

In the present embodiment, the proportion of components of paper furnish was: 20 wt % long fiber, 60 wt % short fiber, and 20 wt % mechanical furnish. The addition amount of the ground calcium carbonate was 25 wt % relative to the weight of fiber. The content of ash in the formed paper was 23 wt %.

In the present embodiment, based on absolutely dried papermaking furnish, the addition amount of ASA emulsion was respectively 1.4, 1.8, and 2.2 kg per ton of absolutely dried papermaking furnish.

The water resistance property of paper sample was tested through the method of Hercules Sizing Test (HST). The testing method of HST is to test the penetration time of ink in the paper through optical method so as to evaluate the water resistance property of paper. The ink used in the test contained 1% formic acid (please refer to Tappi Official Method 530 for the testing method of HST) (Official Method 530 of American Pulp and Paper Industry Association). The testing results are shown in Table 2 below.

TABLE 2
Comparison of sizing effect between the ASA emulsion prepared with
amphoteric polymer emulsifier in the embodiments of the present
invention and the ASA emulsion prepared with cationic starch emulsifier
sizing effect

| | ratio of | | | |
|---|---|---|---|---|
| | emulsifier/ASA | | | |
| | (weight ratio | HST | HST | HST |
| | of effective | (s, 1.4 kg | (s, 1.8 kg | (s, 2.2 kg |
| sample | component) | ASA/T) | ASA/T) | ASA/T) |
| Example 1 | 0.14/1 | 56.4 | 99.8 | 151.2 |
| Example 2 | 0.14/1 | 65.2 | 104.1 | 167.3 |
| Example 3 | 0.14/1 | 35.2 | 64.7 | 117.4 |
| Example 4 | 0.14/1 | 56.9 | 96.7 | 120.3 |
| Example 5 | 0.14/1 | 58.2 | 118.5 | 190.5 |
| Example 6 | 0.14/1 | 56.1 | 106.7 | 171.1 |
| Example 7 | 0.14/1 | 27.3 | 51.5 | 92.8 |
| Example 8 | 0.14/1 | 54.4 | 103.1 | 159.4 |
| Example 9 | 0.14/1 | 75.2 | 126.7 | 202.6 |
| Example 10 | 0.14/1 | 62.3 | 104.8 | 162.5 |
| Example 11 | 0.14/1 | 52.1 | 97.2 | 152.4 |
| Example 12 | 0.14/1 | 65.3 | 116.3 | 182.5 |
| Example 13 | 0.14/1 | 60.3 | 108.2 | 190.1 |
| Example 17 | 0.07/1(starch | 79.5 | 147.5 | 237.5 |
| | post-diluted, | | | |
| | starch/ASA = 1:1) | | | |
| cationic starch | 3/1 | 81.2 | 144.6 | 238.6 |

It can be seen from Table 2 that the ASA emulsion obtained from the emulsifier of the examples of the present application all can achieve good sizing effect. In contrast, the sizing effect of ASA emulsion prepared with the emulsifier of Example 9 provided the best sizing, and under different amounts of ASA, its HST values were all better than the ASA emulsion prepared under other conditions. In addition, it can be seen from Example 17 that the sizing effect of the ASA emulsion diluted by the cationic cooked starch solution further improved.

2) A similar method is used to test the sizing effect of the ASA emulsions prepared with the emulsifier of Example 9 at different ratios of emulsifier to ASA. The results are shown in Table 3 below.

TABLE 3
The sizing effect of the ASA emulsions prepared with the emulsifier
of Example 9 at different ratios of emulsifier to ASA.
Sizing Effect

| | ratio of | | | |
|---|---|---|---|---|
| | emulsifier/ASA | | | |
| | (weight ratio | HST | HST | HST |
| | of effective | (s, 1.4 kg | (s, 1.8 kg | (s, 2.2 kg |
| sample | component) | ASA/T) | ASA/T) | ASA/T) |
| Example 9 | 0.35/1 | 67.5 | 115.4 | 190.5 |
| Example 9 | 0.7/1 | 75.2 | 126.7 | 202.6 |
| Example 9 | 5/1 | 78.3 | 131.3 | 205.1 |

It can be seen from Table 3 that the ASA emulsions prepared with the emulsifier of Example 9 at different ratios of emulsifier to ASA all can achieve good sizing effect.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. (canceled)

2. The alkenyl succinic anhydride emulsion of claim 16, wherein the cationic monomer is selected from diallyl-N,N-dimethyl ammonium chloride, methacryloyloxyethyltrimethylammonium chloride, methacryloyloxyethyltrimethylammonium sulfate, methacryloyloxyethyldimethylphenylammonium chloride, acryloyloxyethyltrimethylammonium chloride, acryloyloxyethyltrimethylammonium sulfate, acryloyloxyethyldimethylphenylammonium chloride, N,N,N-trimethyl-3-(2-methylacrylamino)-1-propyl ammonium chloride, methacrylic N,N′-dimethylamino ethyl ester, methacrylic N,N′-dimethylamino ethyl ester quaternary ammonium salt cation, acrylic-(dimethylamino) ethyl ester, acrylic-(dimethylamino) ethyl ester quaternary ammonium salt, acrylic-(diethylamino) ethyl ester, acrylic-(diethylamino) ethyl ester quaternary ammonium salt, or a combination thereof.

3. The alkenyl succinic anhydride emulsion of claim 16, wherein the anionic monomer is selected from acrylic acid or a salt thereof, methacrylic acid or a salt thereof, or a combination thereof.

4. The alkenyl succinic anhydride emulsion of claim 16, wherein the non-ionic monomer is elected from acrylamide, methacrylamide, N,N-dimethylacrylamide, N,N-diethylacrylamide, N-isopropylacrylamide, N-vinylformamide, N-vinyl-N-methylacetamide, N-vinyl-2-pyrrolidone, or a combination thereof.

5. The alkenyl succinic anhydride emulsion of claim 11, wherein the mole ratio of the non-ionic monomer to the cationic monomer to the anionic monomer to the crosslinker is about 64-94:30-5:10-1:0.05-0.20.

6. The alkenyl succinic anhydride emulsion of claim 11, wherein the mole ratio of the non-ionic monomer to the cationic monomer to the anionic monomer to the crosslinker is about 80-89:15-10:5-1:0.1-0.15.

7-9. (canceled)

10. The alkenyl succinic anhydride emulsion of claim 16, wherein the non-ionic monomer is acrylamide, methacrylamide, N,N-dimethylacrylamide, N,N-diethylacrylamide, N-isopropylacrylamide, N-vinylformamide, N-vinyl-N-methylacetamide, N-vinyl-2-pyrrolidone, or a combination thereof.

11. The alkenyl succinic anhydride emulsion of claim 16, further comprising a crosslinker.

12. The alkenyl succinic anhydride of claim 16, wherein the amphoteric polymer has a molecular weight of from about 100,000 to about 2,000,000 Daltons.

13. The alkenyl succinic anhydride emulsion of claim 16, wherein the amphoteric polymer has a viscosity of from about 10 to about 10,000 cps measured via Brookfield viscometer, #2 spindle, and a rotating speed of 30 rpm.

14. The alkenyl succinic anhydride emulsion of claim 16, wherein the amphoteric polymer has a viscosity of from about 1,000 to about 5,000 cps measured via Brookfield viscometer, #2 spindle, and a rotating speed of 30 rpm.

15. The alkenyl succinic anhydride emulsion of claim 16, further comprising an initiator.

16. An alkenyl succinic anhydride emulsion comprising an alkenyl succinic anhydride and an amphoteric polymer, the amphoteric polymer comprising a cationic monomer, a non-ionic monomer, and an anionic monomer.

17. The alkenyl succinic anhydride emulsion of claim 16, wherein the alkenyl succinic anhydride emulsion comprises about 0.01 to about 20 parts by weight of the amphoteric polymer, about 0.01 to about 20 parts by weight of the alkenyl succinic anhydride, and about 60 to about 99.98 parts by weight of water.

18. A method for sizing paper, the method comprising: adding the alkenyl succinic anhydride emulsion of claim 16 to a papermaking furnish.

19. A method for sizing paper, the method comprising: adding the alkenyl succinic anhydride emulsion of claim 17 to the papermaking furnish.

20. The method of claim 18, wherein the alkenyl succinic anhydride emulsion is added in an amount of from about 0.1 to about 5 kg per ton of dry papermaking furnish.

21. The alkenyl succinic anhydride emulsion of claim 11, wherein the crosslinker is selected from triallylamine, dimethylacrylamide, N,N-methylene diacrylamide, or a combination thereof.

22. The alkenyl succinic anhydride emulsion of claim 15, wherein the initiator is selected from ammonium persulphate, potassium persulphate, sodium persulphate, or a combination thereof.

23. The alkenyl succinic anhydride emulsion of claim 16, wherein the cationic monomer is diallyl-N,N-dimethyl ammonium chloride, the non-ionic monomer is acrylamide, methacrylamide, or a combination thereof, and the anionic monomer is acrylic acid or a salt thereof, methacrylic acid, or a salt thereof, or a combination thereof.

24. A method for sizing paper, the method comprising: adding the alkenyl succinic anhydride emulsion of claim 23 to a papermaking furnish.
